(19) United States
(12) Patent Application Publication
(10) Pub. No.: US 2014/0202145 A1
(43) Pub. Date: Jul. 24, 2014

(54) Control Device and Control Method of Electric Booster

(71) Applicant: HITACHI AUTOMOTIVE SYSTEMS, LTD., Hitachinaka-shi (JP)

(72) Inventors: Yuichi KURAMOCHI, Isesaki-shi (JP); Hiroyuki SAITO, Isesaki-shi (JP)

(73) Assignee: HITACHI AUTOMOTIVE SYSTEMS, LTD., Hitachinaka-shi (JP)

(21) Appl. No.: 13/845,572

(22) Filed: Mar. 18, 2013

(30) Foreign Application Priority Data
Jan. 21, 2013 (JP) 2013-008062

(51) Int. Cl. F15B 15/02

(52) U.S. Cl. CPC F15B 15/02
USPC 60/327; 60/396

(57) ABSTRACT

A control device and a control method of an electric booster include an assist function by an electrical actuator. An input piston of the electric booster moves along an axial direction within the booster piston in response to an operation of a brake pedal. During a brake operation, the control device controls an electric motor to integrally move the input piston and the booster piston while retaining a length of a gap between the input piston and the booster piston. In addition, when starting an internal-combustion engine, the control device performs a control of shortening the length of the gap to prepare for a decrease in power supply voltage of the electric motor. Therefore, a force in a return direction applied to the input piston from the booster piston in association with a power supply drop is suppressed, and causing a driver to feel a sense of discomfort is suppressed.

### BACKGROUND OF THE INVENTION

1. Field of the Invention

The present invention relates to a control device and a control method of an electric booster having an assist function by an electrical actuator.

2. Description of the Related Art

Japanese Laid-open (Kokai) Patent Application Publication No. 2011-131886 A discloses an electric booster including a shaft member that moves by an operation of a brake pedal, a tubular member into which the shaft member is inserted to be relatively movable, and an electrical actuator that moves the tubular member in response to an operation of the brake pedal.

In addition, the above publication discloses a cooperative control that lowers a brake fluid pressure within a master cylinder by driving the tubular member in a backward direction using the electrical actuator as much as a braking force obtained in regenerative brake system.

Incidentally, in general, a vehicle that uses an internal-combustion engine as a power source is required to start up the internal-combustion engine while stepping on the brake pedal. However, when an electric current is applied to a starter motor of the internal-combustion engine so that a battery voltage temporarily decreases, a power supply voltage of an electrical actuator of an electric booster that uses the same battery as a power source decreases.

Then, when the power supply voltage of the electrical actuator of the electric booster decreases, a torque of the electrical actuator decreases, and thus the tubular member moves backward from a position corresponding to an operation of the brake pedal toward an initial position by an applied force of a return spring and a brake fluid pressure, which causes a change in pedal load of the brake pedal, so that a driver may feel a sense of discomfort.

### SUMMARY OF THE INVENTION

Therefore, an object of the invention is to provide a control device and a control method of an electric booster capable of suppressing an occurrence of a change in pedal load of a brake pedal due to a temporary decrease in power supply voltage.

To achieve the above object, the control device of the electric booster according to the invention controls an electrical actuator such that a length of a gap between an input piston and a booster piston is shortened before a power supply voltage of the electrical actuator decreases.

In addition, the control method of the electric booster according to the invention predicts whether a power supply voltage of an electrical actuator decreases, and controls the electrical actuator such that a length of a gap between an input piston and a booster piston is shortened when the decrease in power supply voltage is predicted.

Other objects and features of aspects of this invention will be understood from the following description with reference to the accompanying drawings.

### BRIEF DESCRIPTION OF THE DRAWINGS

FIG. 1 is a cross-sectional view illustrating an initial state of an electric booster of an embodiment of the invention;

FIG. 2 is a cross-sectional view illustrating a state in which the electric booster of the embodiment of the invention generates a braking force;

FIG. 3 is a cross-sectional view illustrating a state in which a cooperative control is performed in the electric booster of the embodiment of the invention;

FIG. 4 is a flowchart illustrating a flow of a control when starting up an engine of the electric booster of the embodiment of the invention; and

FIG. 5 is a timeline chart illustrating a flow of a control when starting up an engine of the electric booster of the embodiment of the invention.

### DESCRIPTION OF THE PREFERRED EMBODIMENTS

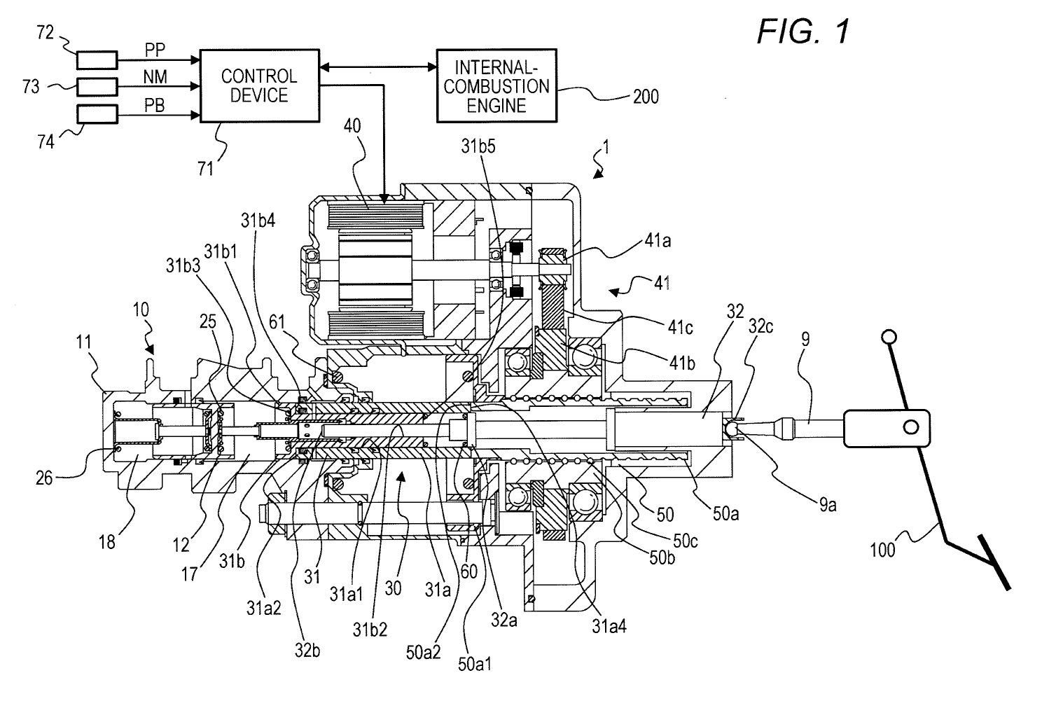

FIG. 1 illustrates an embodiment of an electric booster according to the invention.

An electric booster 1 illustrated in FIG. 1 is a system that assists in decreasing a brake operating force of a driver in a vehicle, and generates assist power by an electrical actuator.

Electric booster 1 includes a tandem master cylinder 10.

Tandem master cylinder 10 includes a cylinder main body 11 having a bottom, and a reservoir (not illustrated).

A secondary piston 12 is provided within cylinder main body 11 at a front side thereof, and secondary piston 12 defines the inside of cylinder main body 11 into two pressure chambers 17 and 18.

In addition, a piston assembly 30 as a primary piston is provided on an input side within cylinder main body 11 so as to face secondary piston 12.

In addition, return springs 25 and 26 that urge piston assembly 30 and secondary piston 12 in a backward direction are provided within each of pressure chambers 17 and 18, respectively.

The configuration of master cylinder 10 is the same as a general tandem master cylinder except for piston assembly 30.

In master cylinder 10, brake fluid contained in each of pressure chambers 17 and 18 is pumped from a discharge port (not illustrated) to a corresponding wheel cylinder in response to a forward movement of both pistons 30 and 12.

Piston assembly 30 includes an input piston 32 which is a shaft member that moves by an operation of a brake pedal 100, and a booster piston 31 which is a tubular member into which input piston 32 is inserted to be relatively movable.

Booster piston 31 includes a tubular member 31a, and a piston member 31b fitted into a hollow portion 31a1 of tubular member 31a.

Input piston 32 is inserted into a hollow portion 31b2 of piston member 31b, and a front-end portion 32b of input piston 32 approaches an inside of pressure chamber 17.

A front-end portion of piston member 31b is provided with a flange portion 31b1 in which an end face 31b3 on a side of pressure chamber 17 receives return spring 25, and an end face 31b4 on an opposite side of pressure chamber 17 comes into contact with an end face 31a2 of tubular member 31a.

When tubular member 31a moves in a direction of approaching secondary piston 12, tubular member 31a comes into contact with flange portion 31b1 of piston member 31b, so that tubular member 31a and piston member 31b integrally moves in the direction of approaching secondary piston 12.

In addition, when piston member 31b moves in a direction of separating from secondary piston 12, flange portion 31b1 comes into contact with tubular member 31a, so that tubular member 31a and piston member 31b integrally moves in the direction of separating from secondary piston 12.

When piston member 31b moves in the direction of approaching secondary piston 12 in a state in which tubular member 31a suspends the movement, piston member 31b moves on the inside of hollow portion 31a1 of tubular member 31a, so that piston member 31b approaches secondary piston 12 in a state in which tubular member 31a suspends the movement.

An intermediate portion of input piston 32 is provided with a flange portion 32a fitted into hollow portion 31a1 of tubular member 31a. A spring 60 is provided in a compressed state between a rear-end portion 31b5 of piston member 31b and flange portion 32a.

In addition, a front-end portion 9a of an input rod 9 operating simultaneously with brake pedal 100 is linked to a rear-end portion 32c of input piston 32, and input piston 32 moves along an axial direction within booster piston 31 in response to an operation of brake pedal 100.

Electric booster 1 is provided with an electric motor 40 corresponding to an electrical actuator, and a ball screw mechanism 50 that converts a rotation of an output shaft of electric motor 40 to a linear movement, and transfers the movement to tubular member 31a of booster piston 31. Ball screw mechanism 50 is a conversion mechanism that converts a rotational movement to a linear movement.

In addition to electric motor 40, a solenoid actuator that drives booster piston 31 by an electromagnetic force and the like may be used as the electrical actuator.

Ball screw mechanism 50 includes a threaded shaft 50a having an external thread formed on an outer periphery, a nut member 50b, and a ball 50c interposed between the external thread of threaded shaft 50a and an internal thread of nut member 50b.

Threaded shaft 50a is non-rotatably supported within housing, and thus threaded shaft 50a moves in response to a rotation of nut member 50b.

A front-end portion 50a2 of threaded shaft 50a is formed so as to come into contact with a rear-end portion 31a4 of tubular member 31a. When threaded shaft 50a moves forward toward secondary piston 12 by electric motor 40, tubular member 31a integrally moves forward by being pushed by threaded shaft 50a.

In addition, a flange portion 50a1 is integrally provided on an outer circumference of threaded shaft 50a, and a return spring 61 that urges threaded shaft 50a to an opposite side of secondary piston 12 is provided between flange portion 50a1 and the housing.

A rotation of electric motor 40 is transferred to nut member 50b via a rotation transfer mechanism 41.

Rotation transfer mechanism 41 includes a first pulley 41a attached to the output shaft of electric motor 40, a second pulley 41b fitted into nut member 50b, and a belt 41c hung and turned between two pulleys 41a and 41b.

Herein, second pulley 41b has a diameter greater than that of first pulley 41a. In this way, a rotation of electric motor 40 is slowed and transferred to nut member 50b.

A driving of electric motor 40 is controlled by a control device 71 including a microcomputer. That is, control device 71 controls electric booster 1 for vehicle through a control of electric motor 40.

A signal is input to control device 71 from a position sensor 72 that detects a position PP of input piston 32, a rotation sensor 73 that detects a rotation NM of electric motor 40, and a pressure sensor 74 that detects a brake fluid pressure PB of pressure chambers 17 and 18 within master cylinder 10, and, based on signals output from the sensors, electric motor 40 is controlled.

Hereinafter, a control of electric booster 1 by control device 71, and an operation of electric booster 1 will be described.

When brake pedal 100 is operated to be depressed by a driver, input piston 32 moves forward integrally with input rod 9, and the movement of input piston 32 is detected by position sensor 72.

Then, control device 71 receives a signal from position sensor 72, and outputs a startup command to electric motor 40. In response to electric motor 40 starting up, a rotation of electric motor 40 is transferred to ball screw mechanism 50, and threaded shaft 50a moves forward. In response to threaded shaft 50a moving forward, tubular member 31a is pushed by threaded shaft 50a, and moves forward. Furthermore, when tubular member 31a pushes flange portion 31b1 of piston member 31b, booster piston 31 follows a movement of threaded shaft 50a.

That is, input piston 32 and booster piston 31 integrally move forward, and a brake fluid pressure corresponding to a thrust force imparted from brake pedal 100 to input piston 32 and a thrust force imparted from electric motor 40 to booster piston 31 is generated in pressure chambers 17 and 18 within tandem master cylinder 10.

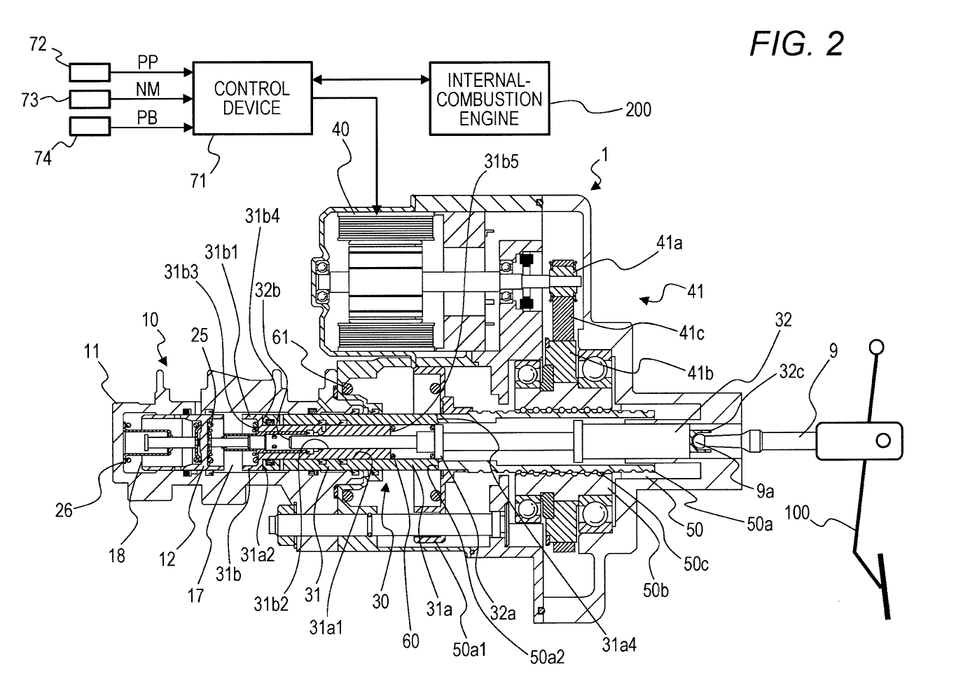

In this instance, an amount of relative displacement of both pistons 31 and 32 is found by a difference between an absolute displacement of input piston 32 and an absolute displacement of booster piston 31. Therefore, as illustrated in FIG. 2, control device 71 controls a rotation of a rotor 42 of electric motor 40 such that a relative displacement is not generated between input piston 32 and booster piston 31.

In an initial position of brake pedal 100, rear-end portion 31b5 of piston member 31b and flange portion 32a of input piston 32 are disposed to face each other with a gap in a moving direction. During a brake operation in which a regenerative brake is not performed, control device 71 controls electric motor 40 so that input piston 32 and booster piston 31 integrally move while substantially retaining the gap.

Thus, a length of a gap between piston member 31b and flange portion 32a in an initial state of FIG. 1 is substantially identical to a length of a gap between piston member 31b and flange portion 32a in a braking state of FIG. 2 in which a regenerative brake is not performed.

In description below, a gap between piston member 31b and input piston 32 corresponds to a space in which rear-end portion 31b5 of piston member 31b and flange portion 32a of input piston 32 face each other in a moving direction, and a length of a gap corresponds to a length of the space in a moving direction of piston member 31b and input piston 32.

When brake pedal 100 is released, electric motor 40 is rotated in a direction opposite to a direction in which brake pedal 100 is depressed to move threaded shaft 50a backward so that booster piston 31 moves backward in response to a movement of input piston 32.

Since a reactive force due to a fluid pressure within master cylinder 10 is applied to booster piston 31, booster piston 31 integrally moves backward by following a backward movement of threaded shaft 50a.

Herein, tubular member 31a of booster piston 31 comes into contact with threaded shaft 50a of ball screw mechanism 50 on an end face. In addition, piston member 31b may further move forward by relatively moving with respect to tubular member 31a coming into contact with threaded shaft 50a.

Therefore, when brake pedal 100 is depressed in a case in which electric motor 40 breaks down, and a torque for moving booster piston 31 forward may not be generated, input piston 32 that moves forward in response to brake pedal 100 being depressed shortens a length of spring 60 to push piston member 31b. In this way, piston member 31b moves forward by following a movement of input piston 32 in a state in which tubular member 31a and threaded shaft 50a are not moved. Then, input piston 32 and piston member 31b integrally move forward to generate a braking force corresponding to a pedal load of brake pedal 100.

In addition, when a regenerative brake system is operated during an operation of brake pedal 100, control device 71 performs a cooperative control that reduces a brake fluid pressure as much as a braking force obtained in the regenerative control.

That is, as described in the foregoing, during a brake operation in which a regenerative control is not performed, piston member 31b is moved forward by electric motor 40 in response to a displacement of input piston 32 so as to retain the length of the gap between piston member 31b and flange portion 32a of input piston 32.

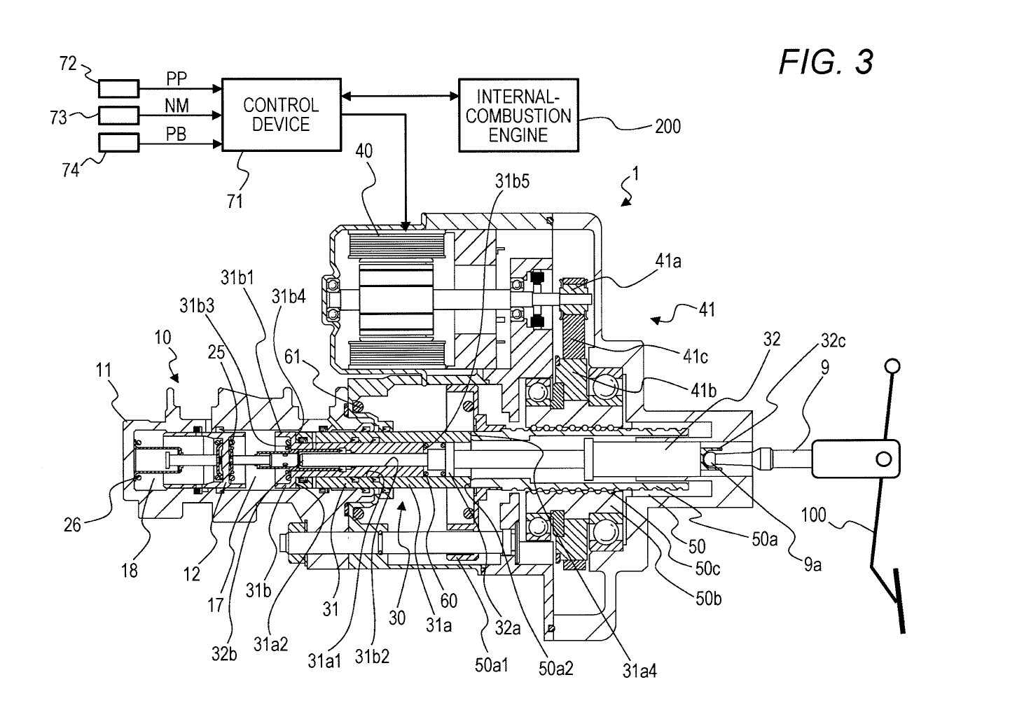

In a cooperative control, electric motor 33 is rotated in a direction opposite to a direction in which a braking is performed from a state illustrated in FIG. 2, and booster piston 31 is moved backward as illustrated in FIG. 3, so that a length of a gap between piston member 31b and input piston 32 is shortened so as to reduce a brake fluid pressure as much as a braking force obtained in the regenerative control. A distance in which booster piston 31 moves back is set to a value less than or equal to a gap provided between piston member 31b and flange portion 32a in a state in which the regenerative control is not performed. Therefore, in association with a cooperative control, it is possible to inhibit a driver from feeling a change in pedal load of brake pedal 100 without a force in a return direction being applied to input piston 32 from piston member 31b.

As described in the foregoing, control device 71 has a function of a brake control unit or a brake control means that controls electric motor 40 such that input piston 32 and booster piston 31 integrally move while retaining a length of the gap for an operation of brake pedal 100, and reduces a brake fluid pressure within master cylinder 10 by controlling electric motor 40 such that the length of the gap is shortened during the regenerative control.

A vehicle including electric booster 1 is equipped with an internal-combustion engine 200 as a power source, and drives a starter motor in response to a start operation of internal-combustion engine 200 by a driver to crank internal-combustion engine 200 under a condition that brake pedal 100 is depressed.

In a case of the vehicle, when controlling electric motor 40 by control device 71 as described above, there is a possibility that a pedal load of brake pedal 100 changes during a cranking to cause a driver to feel a sense of discomfort.

That is, when a voltage of a battery VB corresponding to a power source of the starter motor is decreased by driving the starter motor, and cranking internal-combustion engine 200, an applied voltage of electric motor 40 that uses the same battery VB as a power source decreases. That is, when the battery VB is a power source for starting up internal-combustion engine 200, and is a power source of electric motor 40, a power supply voltage of electric motor 40 decreases while starting up internal-combustion engine 200.

When an applied voltage of electric motor 40 decreases, a torque of electric motor 40 that moves booster piston 31 forward by resisting a brake fluid pressure or return spring 61 temporarily decreases, and thus booster piston 31 is to return to an initial position using a force of return spring 61 or the brake fluid pressure.

In this case, piston member 31b of booster piston 31 moves toward input piston 32 which is not moved, to shorten a length of the gap, and comes into contact with input piston 32 with kinetic energy. Therefore, a force in a return direction is applied to input piston 32, which may cause a driver to feel a sense of discomfort, that is, a change in pedal load of brake pedal 100.

Therefore, when internal-combustion engine 200 is started in a state in which brake pedal 100 is depressed, control device 71 performs a control of shortening a length of the gap between piston member 31b and flange portion 32a, that is, a control of causing piston member 31b to approach flange portion 32a to prepare for a decrease in battery voltage associated with a cranking when internal-combustion engine 200 is started in a state in which brake pedal 100 is stepped on. In this way, a power supply voltage of electric motor 40 associated with an engine starting is decreased in a state in which piston member 31b and flange portion 32a approach each other. That is, control device 71 has a function as a control unit or a control means that performs a control of shortening the gap.

When a length of the gap between piston member 31b and input piston 32 is shorter than a standard value, a distance in which piston member 31b moves until touching flange portion 32a is shortened, and kinetic energy decreases even when a power supply voltage of electric motor 40 decreases, and a motor torque decreases. Thus, a force in a return direction applied to input piston 32 by piston member 31b decreases, and it is possible to suppress a change in pedal load of brake pedal 100.

In general, a start of internal-combustion engine 200 in an automatic transmission car is performed in a P range or an N range, and thus a sufficient braking force may be ensured even when a control of shortening the length of the gap between piston member 31b and flange portion 32a is performed.

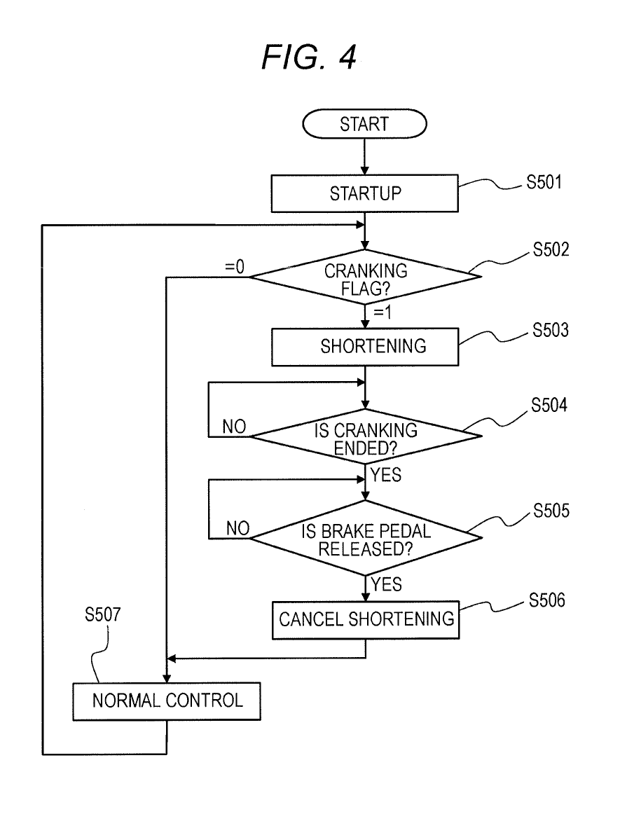

A flowchart of FIG. 4 illustrates an example of a control of electric booster 1 during an engine starting by control device 71.

First, when power is applied to control device 71 in step S501, it is determined whether a cranking flag rises in subsequent step S502.

Power is applied to control device 71 in response to one of depressing of brake pedal 100, opening of a door of a vehicle, unlocking of a door of a vehicle, sitting on a seat of a driver, an operation of an ignition switch, and the like. For example, when a monitoring unit that monitors depressing of brake pedal 100, a door state, and the like is being operated, and brake pedal 100 is depressed even before an operation of an ignition switch, power may be applied to control device 71 based on a start request signal from the monitoring unit.

When a cranking flag falls, the operation proceeds to step S507, and piston member 31b is moved by electric motor 40 in response to a displacement of input piston 32 so that a length of a gap between piston member 31b and flange portion 32a of input piston 32 is retained at a standard value (initial value). In addition, in a cooperative control, piston member 31b is moved backward by electric motor 40 to shorten the length of the gap between piston member 31b and input piston 32.

On the other hand, when power is applied to the starter motor, and a cranking flag rises, a decrease in power supply voltage associated with a start of internal-combustion engine 200 is predicted, and the operation proceeds to step S503. In step S503, a control is performed to shorten the length of the gap between piston member 31b and flange portion 32a so that the length is shorter than the standard value. In other words, when applying electric current to the starter motor of internal-combustion engine 200 is started, the electric motor is controlled so that the length of the gap is shortened.

When depressing of brake pedal 100 before a start switch is turned ON is determined from a brake switch and the like in place of determination of a cranking flag, and depressing of brake pedal 100 is detected, it is possible to predict a decrease in power supply voltage associated with a start of internal-combustion engine 200, and perform a control of shortening the length of the gap between piston member 31b and flange portion 32a so that the length is shorter than the standard value.

When a driver depresses brake pedal 100 to start internal-combustion engine 200 after power is applied to control device 71, input piston 32 moves forward, and control device 71 controls electric motor 40 in response to an output of position sensor 72 so that booster piston 31 moves forward integrally with input piston 32.

In the control of electric motor 40, input piston 32 and booster piston 31 are integrally moved forward so that the length of the gap between piston member 31b and flange portion 32a is substantially retained at the standard value which is a length at an initial position.

In this way, when the operation proceeds to step S503 in a state in which the length of the gap is retained at the standard value, a torque that moves threaded shaft 50a backward is generated by rotating electric motor 40 in an opposite direction, and booster piston 31 is moved backward integrally with threaded shaft 50a. Herein, a distance in which threaded shaft 50a is moved backward is within a range in which piston member 31b does not come into contact with input piston 32, and is a distance set for a cranking which is shorter than the standard value of the length of the gap between piston member 31b and flange portion 32a.

When the length of the gap between piston member 31b and flange portion 32a is shortened, kinetic energy given to booster piston 31 decreases when compared to a case in which the length of the gap is the standard value since a distance at which piston member 31b moves until touching flange portion 32a is shortened even when a torque of electric motor 40 decreases in association with a power supply drop, and threaded shaft 50a is to return to an initial position. Therefore, a force in a return direction applied to input piston 32 by piston member 31b is weakened, and thus it is possible to suppress a change in pedal load of brake pedal 100.

A length of a gap for a cranking is set to a value at which a change in pedal load of brake pedal 100 in response to a decrease in torque of electric motor 40 is within a permissible range.

When brake pedal 100 is depressed before power is applied to control device 71, input piston 32 comes into contact with piston member 31b, and pushes piston member 31b to generate a brake fluid pressure. That is, a length of a gap between piston member 31b and flange portion 32a has a minimum value.

When the operation proceeds to step S503 in the above state, a driving for moving threaded shaft 50a forward by electric motor 40 to set the length of the gap between piston member 31b and flange portion 32a to the standard value is canceled, and a state in which input piston 32 and piston member 31b come into contact with each other is retained, or electric motor 40 is driven to move piston member 31b forward so that the length of the gap is set to a value for a cranking which is shorter than the standard value.

The above processing of canceling driving of electric motor 40, and the processing of driving electric motor 40 to move piston member 31b forward are included in a control of shortening the length of the gap so that the length is less than the standard value.

In addition, a control of shortening the length of the gap between piston member 31b and flange portion 32a so that the length is less than the standard value is not limited to a configuration in which the control is performed at a point in time when a cranking flag rises, and may be performed before an engine starting in which a cranking flag falls.

That is, when a control of shortening the length of the gap up to a length set for a cranking is performed before a drop of a power supply voltage of electric motor 40, that is, in response to predicting a drop of a battery voltage by a cranking, it is possible to suppress a change in pedal load of brake pedal 100.

For example, the control of shortening the length of the gap may be performed when power is applied to control device 71, brake pedal 100 is depressed, and internal-combustion engine 200 is to be started.

Furthermore, in addition to the above condition, a state in which power is applied to internal-combustion engine 200, that is, a key switch is turned on may be added as a condition.

The control of shortening the length of the gap is performed, and a cranking is performed in a state in which the length of the gap is shortened in step S503, and it is determined whether a cranking is ended in step S504.

That is, in the determination of step S504, it is determined whether a period of time at which a power supply voltage of electric motor 40 temporarily decreases is passed.

Therefore, in the determination of step S504, switching of the starter motor from an ON state to an OFF state, an engine speed of internal-combustion engine 200 being greater than or equal to a set speed, an increase of a battery voltage, and the like may be determined as an end of the cranking. In addition, the end of the cranking may be determined from a combination thereof.

When the cranking is not ended, a power supply voltage of electric motor 40 may decrease during the cranking, and thus a state in which the length of the gap is shortened is retained.

On the other hand, when the cranking is ended, it is estimated that a power supply voltage of electric motor 40 is restored. In this case, the operation proceeds to step S505.

In step S505, it is determined whether or not brake pedal 100 is released as an operation of causing a vehicle to start to move.

When an amount of releasing brake pedal 100 exceeds a set value, it is determined that brake pedal 100 is released in step S505, and the operation proceeds to step S506 to cancel a control of shortening the length of the gap for a cranking.

Herein, when an application of an electric current to electric motor 40 is suspended, booster piston 31 is to return to an initial position by an applied force of return spring 61, and input piston 32 moves backward in association with the releasing of brake pedal 100, and thus a state returns to an initial state in which the length of the gap is a default.

Therefore, the length of the gap is retained at a shorter length than a length at which a vehicle starts to move, that is, a shorter length than a length at which booster piston 31 and input piston 32 are at an initial position at least during the cranking of internal-combustion engine 200, and brake pedal 100 is released after internal-combustion engine 200 is started, and then electric motor 40 is controlled so that the length of the gap is extended.

It is possible to generate a torque by electric motor 40 to move booster piston 31 backward toward an initial position.

On the other hand, when brake pedal 100 depressed before the cranking retains a state of being depressed after the end of the cranking, a state in which the length of the gap is shortened is retained. In this way, causing a driver to feel a sense of discomfort is suppressed in association with a control of extending the length of the gap.

In this regard, it is possible to return the length of the gap before releasing brake pedal 100 after the end of the cranking. In this case, a torque of electric motor 40 is generated in a direction of moving booster piston 31 forward.

After the operation proceeds to step S506 to cancel the control of shortening the length of the gap for a cranking, the operation proceeds to step S507 to perform a normal control.

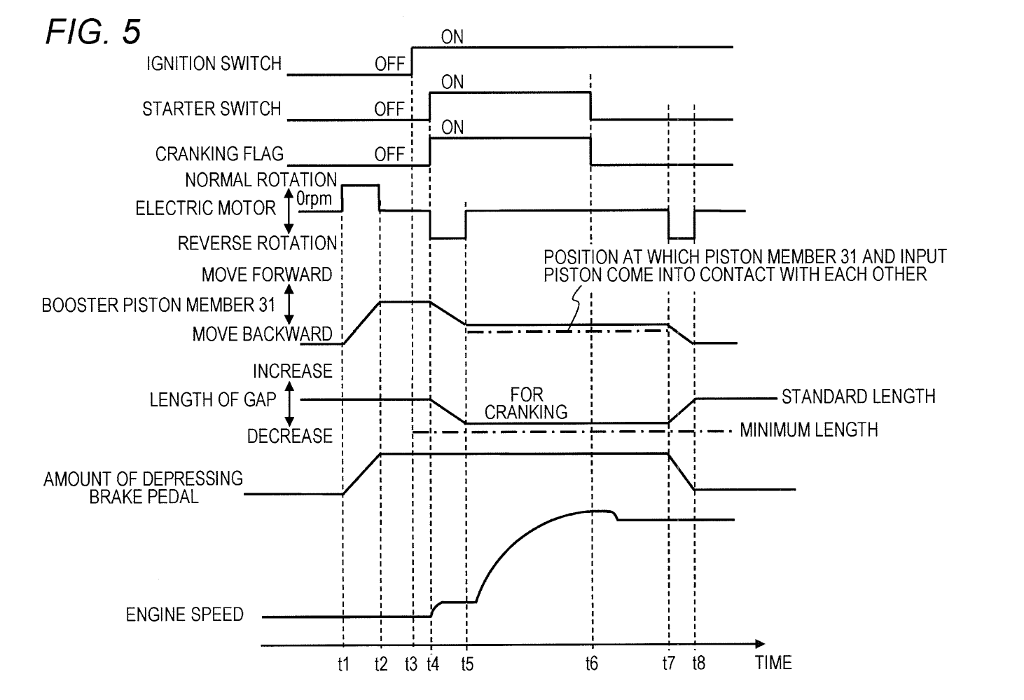

A timeline chart of FIG. 5 illustrates an example of an operation of electric booster 1 during an engine starting.

The example illustrated in the timeline chart of FIG. 5 illustrates a case in which power is applied to control device 71 before an ignition switch is turned ON, so that a drive control of electric motor 40 may be performed before the ignition switch is turned ON.

In the timeline chart of FIG. 5, when depressing of brake pedal 100 is started at a point in time t1 before the ignition switch is turned ON, electric motor 40 is driven to a normal rotation side until a point in time t2 at which a depressing operation is ended so that booster piston 31 is moved forward in response to input piston 32 moving forward in association with the depressing of brake pedal 100. In this way, booster piston 31 is moved forward integrally with input piston 32 while retaining the length of the gap. The normal rotation of electric motor 40 corresponds to a rotation direction in which booster piston 31 is moved forward.

Thereafter, when a driver turns ON the ignition switch at a point in time t3, and turns ON a starter switch at a point in time t4 to start up internal-combustion engine 200, a cranking flag rises.

When the cranking flag rises at the point in time t4, electric motor 40 is driven to a reverse rotation side, that is, in a direction of moving booster piston 31 backward from the point in time t4 to a point in time t5 so as to shorten the length of the gap, and booster piston 31 is moved backward by a torque generated by electric motor 40, so that the length of the gap is decreased up to a value set in advance for a cranking.

Then, when the starter switch is turned OFF at a point in time t6, and then brake pedal 100 is released at a point in time t7, a control of shortening the length of the gap for the cranking is canceled.

When an application of an electric current to electric motor 40 is suspended in association with the cancel of the control of shortening the length of the gap, input piston 32 moves backward in association with the releasing of brake pedal 100, and booster piston 31 moves backward by an applied force of a spring, and thus input piston 32 and booster piston 31 return to an initial position and return to the initial position at a point in time t8 while the length of the gap is extended.

A reverse rotation of electric motor 40 from the point in time t7 to the point in time t8 of FIG. 5 is a rotation generated when electric motor 40 is driven from a side of booster piston 31 in response to booster piston 31 moving backward by an applied force of a spring. In this regard, it is possible to generate a torque in a direction of moving booster piston 31 backward by applying an electric current to electric motor 40.

As described in the foregoing, when a state in which the length of the gap is sufficiently short is retained during the cranking in which a power supply voltage of electric motor 40 decreases, it is possible to suppress a change in pedal load of brake pedal 100 even when a torque of electric motor 40 rapidly decreases due to a decrease in power supply voltage in association with the cranking.

In electric booster 1 of the embodiment, since the length of the gap returns to a standard value when threaded shaft 50a and input piston 32 return to a mechanical stopper position in response to brake pedal 100 being released, it is possible to perform a control of continuing a state in which the length of the gap is shortened until brake pedal 100 which is depressed before the cranking is released, and retaining the length of the gap at the standard value in subsequent brake pedal depressing.

In addition, it is possible to apply the control of shortening the length of the gap to a vehicle excluding regenerative brake system.

In addition, in the embodiment, the control of shortening the length of the gap is performed as a countermeasure for a decrease in power supply voltage of electric motor 40 in association with a start of internal-combustion engine 200. However, the control of shortening the length of the gap may be applied to a voltage drop due to a cause other than a starting of a vehicle in a stopped state.

In addition, when an electric current is applied to another electrical component such as a headlight in a case in which a cranking is performed by applying an electric current to the starter motor, a voltage drop increases, and a torque outage of electric motor 40 easily occurs. Therefore, it is determined whether the number of other electrical components to which an electric current is applied when starting the cranking is greater than the preset number of electrical components. When the number of electrical components to which an electric current is applied is greater than the preset number of electrical components, the control of shortening the length of the gap may be performed.

In addition, when a temperature of internal-combustion engine 200 is low, power used for starting increases, and a voltage easily drops. Thus, when a temperature of internal-combustion engine 200 at the time of a starting is less than a set temperature, the control of shortening the length of the gap may be performed.

The entire contents of Japanese Patent Application No. 2013-008062, filed Jan. 21, 2013, are incorporated herein by reference.

While only selected embodiments have been chosen to illustrate the present invention, it will be apparent to those skilled in the art from this disclosure that various changes and modifications can be made herein without departing from the scope of the invention as defined in the appended claims.

Furthermore, the foregoing description of the embodiments according to the present invention is provided for illustration only, and not for the purpose of limiting the invention, the invention as claimed in the appended claims and their equivalents.

What is claimed is:

1. A control device of an electric booster which includes an input piston that moves by an operation of a brake pedal, a booster piston that is relatively movable with respect to the input piston, and an electrical actuator that moves the booster piston in response to an operation of the brake pedal, drives a piston of a master cylinder by the input piston and the booster piston, and generates a brake fluid pressure within the master cylinder, comprising
a control unit that controls the electrical actuator to shorten a length of a gap between the input piston and the booster piston before a decrease in power supply voltage of the electrical actuator.

2. The control device of the electric booster according to claim 1,
wherein a power source of the electrical actuator is a power source used for a starting of an internal-combustion engine, and
the control unit controls the electrical actuator before a decrease in power supply voltage associated with the starting of the internal-combustion engine.

3. The control device of the electric booster according to claim 2,
wherein the control unit controls the electrical actuator to shorten the length of the gap when applying electric current to a starter motor of the internal-combustion engine is started.

4. The control device of the electric booster according to claim 2,
wherein the control unit controls the electrical actuator to extend the length of the gap after the starting of the internal-combustion engine.

5. The control device of the electric booster according to claim 2,
wherein the control unit controls the electrical actuator to extend the length of the gap when the brake pedal is released after the starting of the internal-combustion engine.

6. The control device of the electric booster according to claim 2,
wherein the control unit retains the length of the gap at a shorter length than a length at which a vehicle starts to move at least during a cranking of the internal-combustion engine.

7. The control device of the electric booster according to claim 2,
wherein the control unit retains the length of the gap at a shorter length than a length at which the input piston and the booster piston are at an initial position at least during a cranking of the internal-combustion engine.

8. The control device of the electric booster according to claim 2,
wherein the control unit controls the electrical actuator before a decrease in power supply voltage associated with the starting of the internal-combustion engine when a temperature of the internal-combustion engine during the starting is lower than a preset temperature.

9. The control device of the electric booster according to claim 2,
wherein the control unit controls the electrical actuator before a decrease in power supply voltage associated with the starting of the internal-combustion engine when the number of electrical components to which an electric current is applied is greater than the preset number of electrical components in a vehicle.

10. The control device of the electric booster according to claim 1, further comprising
a brake control unit that controls the electrical actuator such that the input piston and the booster piston integrally move while retaining the length of the gap in response to the operation of the brake pedal, and reduces a brake fluid pressure within the master cylinder by controlling the electrical actuator such that the length of the gap is shortened during a regenerative control.

11. The control device of the electric booster according to claim 10,
wherein the brake control unit is started before a start operation of an internal-combustion engine, and controls the electrical actuator in response to the operation of the brake pedal before the start operation of the internal-combustion engine.

12. The control device of the electric booster according to claim 1,
wherein the electrical actuator is an electric motor, and
the electric booster includes a ball screw mechanism which transfers a rotation of an output shaft of the electric motor to the booster piston.

13. The control device of the electric booster according to claim 1,
wherein the input piston includes a shaft member, and the booster piston includes a tubular member into which the shaft member is inserted to be relatively movable.

14. The control device of the electric booster according to claim 1,
wherein power is applied to the control device when performing at least one of the operation of the brake pedal and an opening of a vehicle door.

15. A control device of an electric booster which includes an input piston that moves by an operation of a brake pedal, a booster piston that is relatively movable with respect to the input piston, and an electrical actuator that moves the booster piston in response to an operation of the brake pedal, drives a piston of a master cylinder by the input piston and the booster piston, and generates a brake fluid pressure within the master cylinder, comprising
a control means that controls the electrical actuator to shorten a length of a gap between the input piston and the booster piston before a decrease in power supply voltage of the electrical actuator.

16. A control method of an electric booster which includes an input piston that moves by an operation of a brake pedal, a booster piston that is relatively movable with respect to the input piston, and an electrical actuator that moves the booster piston in response to an operation of the brake pedal, drives a piston of a master cylinder by the input piston and the booster piston, and generates a brake fluid pressure within the master cylinder, comprising the steps of:
predicting whether or not a power supply voltage of the electrical actuator decreases; and
controlling the electrical actuator to shorten a length of a gap between the input piston and the booster piston when the decrease in power supply voltage is predicted.

17. The control method of the electric booster according to claim 16,
wherein the step of predicting whether or not the power supply voltage decreases includes predicting whether or not power supply voltage of the electrical actuator decreases when an internal-combustion engine that shares a power source with the electrical actuator is started.

18. The control method of the electric booster according to claim 16,
wherein the step of predicting whether or not the power supply voltage decreases includes predicting whether or not the power supply voltage decreases when applying electric current to a starter motor of an internal-combustion engine is started, and the internal-combustion engine shares a power source with the electrical actuator.

19. The control method of the electric booster according to claim 17, further comprising the step of
controlling the electrical actuator to extend the length of the gap after the internal-combustion engine is started.

20. The control method of the electric booster according to claim 17, further comprising the step of
controlling the electrical actuator to extend the length of the gap when the brake pedal is released after the internal-combustion engine is started.
